(19) United States
(12) Patent Application Publication
(10) Pub. No.: US 2026/0154203 A1
(43) Pub. Date: Jun. 4, 2026

(54) PROCESSOR, INFORMATION PROCESSING DEVICE, AND CONTROL METHOD OF PROCESSOR

(71) Applicant: Fujitsu Limited, Kawasaki-shi (JP)

(72) Inventors: Yuki KAMIKUBO, Yokohama (JP); Nao ENDO, Kawasaki (JP)

(73) Assignee: Fujitsu Limited, Kawasaki-shi (JP)

(21) Appl. No.: 19/404,065

(22) Filed: Dec. 1, 2025

(30) Foreign Application Priority Data
Dec. 2, 2024 (JP) 2024-209527

(51) Int. Cl. G06F 12/0862

(52) U.S. Cl. CPC G06F 12/0862; G06F 2212/1024

(57) ABSTRACT

A processor includes a cache that holds data read from a memory by a memory access request; a prefetch queue including entries to be respectively assigned to streams, each of the entries being used to control prefetching of data from the memory to the cache for a corresponding stream, the streams being memory access requests for consecutive addresses; a stride setting circuit that adjusts a stride in accordance with a number of valid entries to which the streams are respectively assigned, and reduces the stride as the number of the valid entries increases, the stride being a change amount between an access address and a prefetch destination address; and a prefetch management circuit that issues a prefetch request to the memory, using the adjusted stride, upon or after a number of the memory access requests for the consecutive addresses reaching a first threshold value for each of the streams.

### CROSS-REFERENCE TO RELATED APPLICATIONS

This application is based upon and claims the benefit of priority of the prior Japanese Patent Application No. 2024-209527, filed on December 2, 2024, the entire contents of which are incorporated herein by reference.

### FIELD

The present disclosure relates to a processor, an information processing device, and a control method of the processor.

### BACKGROUND

A processor such as a central processing unit (CPU) includes a cache for storing part of data stored in a main storage device to conceal access latency and improve throughput. As a technique for improving a cache hit rate and concealing an access latency, a prefetch technique is known in which data expected to be used in the near future is read into a cache in advance. One of the prefetch techniques is hardware prefetch (for example, see Patent Documents 1 and 2).

### Related Art Documents

Patent Document 1 Japanese Patent Application Laid-open No. 2005-242527

Patent Document 2 Japanese Patent Application Laid-open No. 2017-045153

### SUMMARY

According to an aspect of the embodiments, a processor includes a cache configured to hold data read from a memory by a memory access request; a prefetch queue including a plurality of entries to be respectively assigned to streams, each of the plurality of entries being used to control prefetching of data from the memory to the cache for a corresponding stream among the streams, the streams being a plurality of memory access requests for consecutive addresses; a stride setting circuit configured to adjust a stride in accordance with a number of valid entries to which the streams are respectively assigned among the plurality of entries, and reduce the stride as the number of the valid entries increases, the stride being a change amount between an access address included in the memory access request and a prefetch destination address; and a prefetch management circuit configured to issue a prefetch request to the memory, using the stride adjusted by the stride setting circuit, for each of the memory access requests for the consecutive addresses, upon or after a number of the memory access requests for the consecutive addresses reaching a preset first threshold value for each of the streams.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a processor in an embodiment;

FIG. 2 is a block diagram illustrating an example of a structure of a prefetch queue of FIG. 1;

FIG. 3 is a block diagram illustrating an example of a configuration of a stride setting circuit of FIG. 1;

FIG. 4 is an explanatory diagram illustrating an example of a prefetch operation by a prefetch control circuit of FIG. 1;

FIG. 5 is a diagram illustrating an example of a change in a state of an entry in the prefetch queue when the operation of FIG. 4 is performed;

FIG. 6 is an explanatory diagram illustrating an example of a method of generating a correction value by a correction value generator of FIG. 3;

FIG. 7 is an explanatory diagram illustrating an example of a method of generating a prefetch distance by a prefetch distance generator of FIG. 3;

FIG. 8 is a flow diagram illustrating an example of an operation of a prefetch queue management circuit of FIG. 1;

FIG. 9 is a flow diagram illustrating an example of an operation of step S200 of FIG. 8; and

FIG. 10 is a flow diagram illustrating an example of an operation of step S210 of FIG. 9.

### DESCRIPTION OF EMBODIMENTS

For example, when a processor having a hardware prefetch function detects stream accesses, which are a plurality of memory accesses for consecutive addresses, the processor sequentially issues prefetch requests in the direction of the consecutive addresses. Hereinafter, memory access processes by stream accesses are also referred to as streams, and a difference between an address included in a memory access request and a prefetch destination address is also referred to as a stride. Additionally, the stride is set to an integer multiple of a minimum stride, and the multiplier for the minimum stride is referred to as a prefetch distance.

In order to suppress deterioration in the cache usage efficiency, it is preferable that data to be prefetched is stored in the cache immediately before the data is read from the cache by a memory access request. However, if the prefetch distance is too short, the target data may be stored in the cache after the memory access request for reading the target data is issued, and thus there is a risk that a cache miss occurs and processing performance is degraded. Additionally, if the prefetch distance is too long, the target data may be stored in the cache memory relatively early, and other necessary data may be evicted from the cache memory, and thus there is a risk that a cache miss occurs and processing performance is degraded.

Further, when a processor executes a plurality of programs in parallel and a stream is generated for each of the programs, the appropriate prefetch distance changes according to a change in the number of streams. For example, when the number of streams is large, the frequency of memory access requests for each of the streams decreases.

When the frequency of memory access requests is low and the prefetch distance is long, the storage timing of the target data in the cache memory by prefetching precedes the generation timing of the memory access request for the target data. As a result, there is a risk that other necessary data held in the cache memory is evicted from the cache memory before being used, thereby causing performance deterioration. Additionally, when a memory access request for the data stored by prefetching occurs, if the target data is already evicted from the cache memory, the effect of prefetching cannot be obtained. Therefore, it is preferable to reduce the prefetch distance.

With respect to the above, when the number of streams is small, the frequency of memory access requests for each of the streams increases. When the frequency of memory access requests is high and the prefetch distance is short, if the memory access request for the target data occurs before the storage timing of the target data in the cache memory by prefetching, the effect of prefetching cannot be obtained. Therefore, it is preferable to increase the prefetch distance.

If the prefetch distance cannot be changed regardless of the number of streams, the prefetch distance may be too short or too long depending on the characteristics of a program executed by the processor, and there is a case where the effect of improving the processing performance of the processor by prefetching is not sufficiently obtained. However, a technique for changing the prefetch distance in accordance with the number of streams has not been proposed.

The processing performance of a processor can be improved by dynamically changing the prefetch distance in accordance with the number of streams.

Embodiments will be described below with reference to the drawings. In the following, the same reference numerals as the names of the signals are used for the signal lines through which the signals are transmitted.

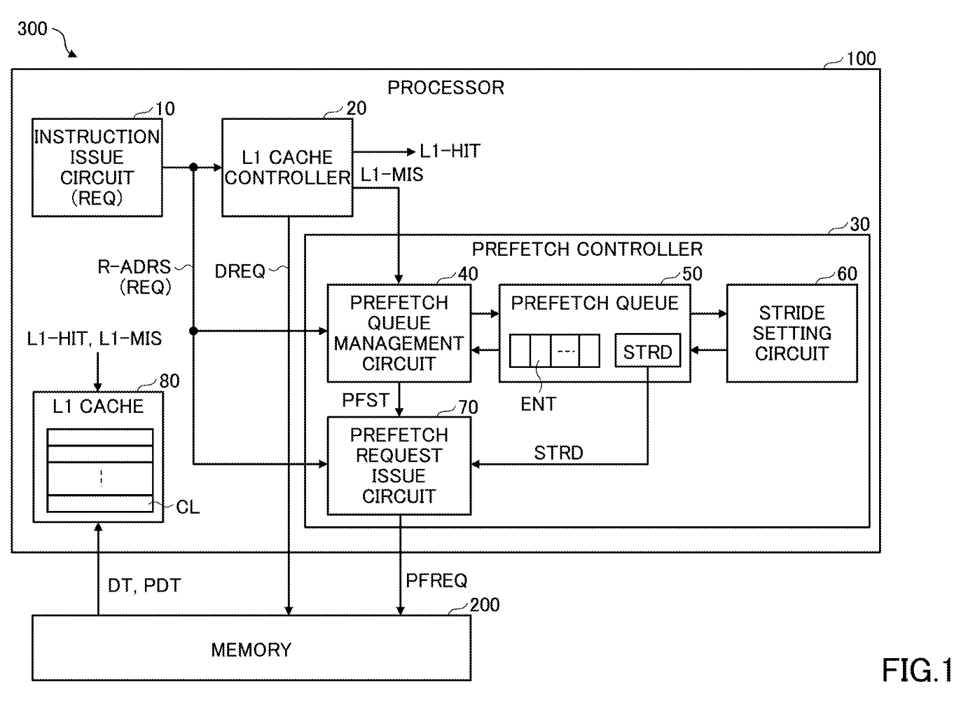

FIG. 1 illustrates an example of a processor according to an embodiment. A processor 100 illustrated in FIG. 1 includes an instruction issue circuit 10, a level 1 (L1) cache controller 20, a prefetch controller 30, and an L1 cache 80. The prefetch controller 30 includes a prefetch queue management circuit 40, a prefetch queue 50, a stride setting circuit 60, and a prefetch request issue circuit 70. For example, the processor 100 is mounted in an information processing device 300 together with a memory 200 such as a main memory. Here, the memory 200 is not limited to the main memory and may be a level 2 (L2) cache disposed between the L1 cache 80 and the main memory.

In the following, an example in which the prefetch controller 30 controls prefetching of data from the memory 200 to the L1 cache 80 (data cache) based on an address included in a memory access request REQ such as a load instruction will be described. However, the prefetch controller 30 may control prefetching of an instruction from the memory 200 to the L1 cache 80 (instruction cache) based on an instruction fetch address generated based on a program counter. In this case, instructions held in the memory 200 and the L1 cache 80 are treated as data.

When the instruction fetched from the memory 200 is the memory access request REQ, the instruction issue circuit 10 generates a request address R-ADRS of the memory access request REQ by an operand address generator, which is not illustrated, and outputs the generated request address R-ADRS. The request address R-ADRS is output to the L1 cache controller 20, the prefetch queue management circuit 40, and the prefetch request issue circuit 70. The request address R-ADRS is an example of an access address. Here, when the instruction fetched from the memory 200 is an arithmetic instruction, the instruction issue circuit 10 may issue the arithmetic instruction to an arithmetic unit, which is not illustrated.

The L1 cache controller 20 determines whether operand data to be handled by the memory access request REQ output from the instruction issue circuit 10 is stored in the L1 cache 80. When the operand data is stored in the L1 cache 80, the L1 cache controller 20 outputs a cache hit signal L1-HIT. When the operand data is not stored in the L1 cache 80, the L1 cache controller 20 outputs a cache miss signal L1-MIS and issues a data request DREQ (i.e., a memory access request) to the memory 200.

In the prefetch controller 30, the prefetch queue 50 includes a plurality of entries ENT used for managing prefetching of data from the memory 200 to the L1 cache 80 for respective stream accesses, which are the memory accesses for a plurality of consecutive blocks. Additionally, the prefetch queue 50 includes a stride holding section for holding a stride STRD commonly used for the plurality of entries ENT.

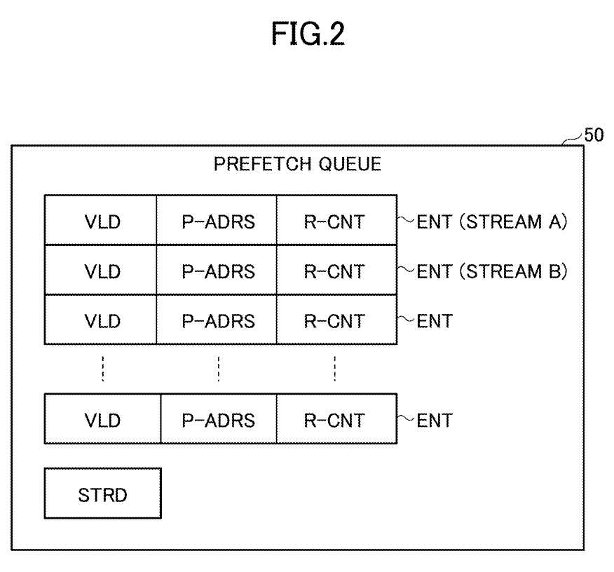

Hereinafter, the memory access processing by the stream access is referred to as a stream. By providing the plurality of entries ENT and the stride holding section in the prefetch queue 50, the prefetch controller 30 can control prefetching of data from the memory 200 in each of the plurality of streams. An example of the prefetch queue 50 is illustrated in FIG. 2.

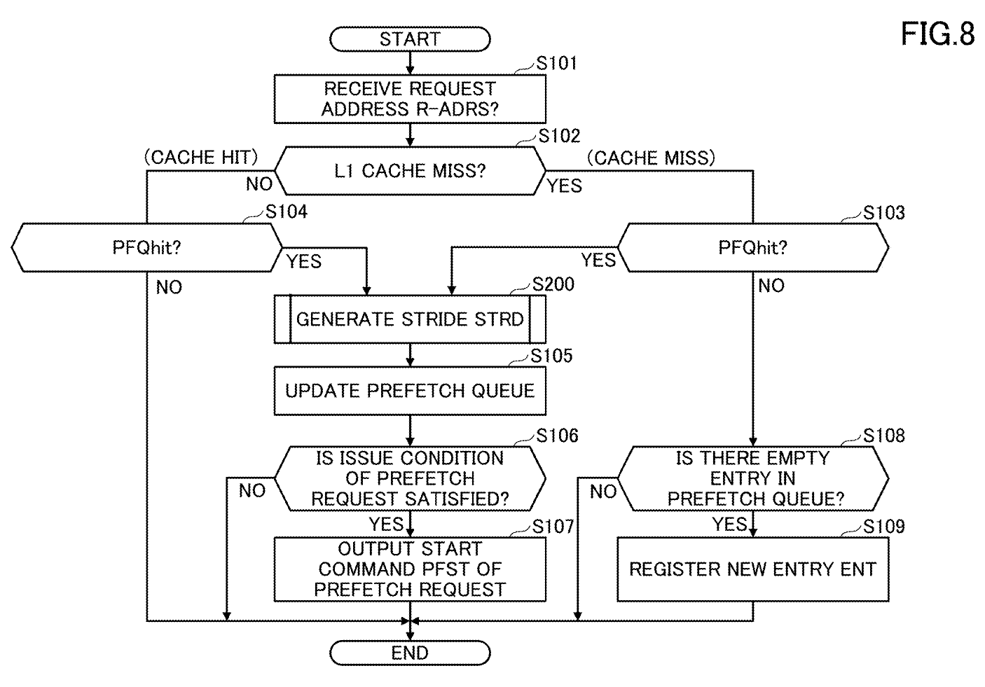

The prefetch queue management circuit 40 updates, based on the cache miss signal L1-MIS, information held in a corresponding entry ENT. When the information held in the corresponding entry ENT satisfies an issuing condition of a prefetch request PFREQ, the prefetch queue management circuit 40 outputs a start instruction PFST of the prefetch request to the prefetch request issue circuit 70. An example of the operation of the prefetch queue management circuit 40 is illustrated in FIG. 8.

The stride setting circuit 60 dynamically adjusts the prefetch distance and the stride STRD, based on the information held in the entry ENT corresponding to the stream. The prefetch distance is indicated by an integer (i.e., a multiplier) indicating how many multiples of the minimum stride the stride STRD, which is the address difference from the request address R-ADRS included in the memory access request REQ to the prefetch destination address, corresponds to. That is, the prefetch distance indicates the number of units of the stride STRD that is set by the stride setting circuit 60 when the minimum stride STRD is defined as one unit.

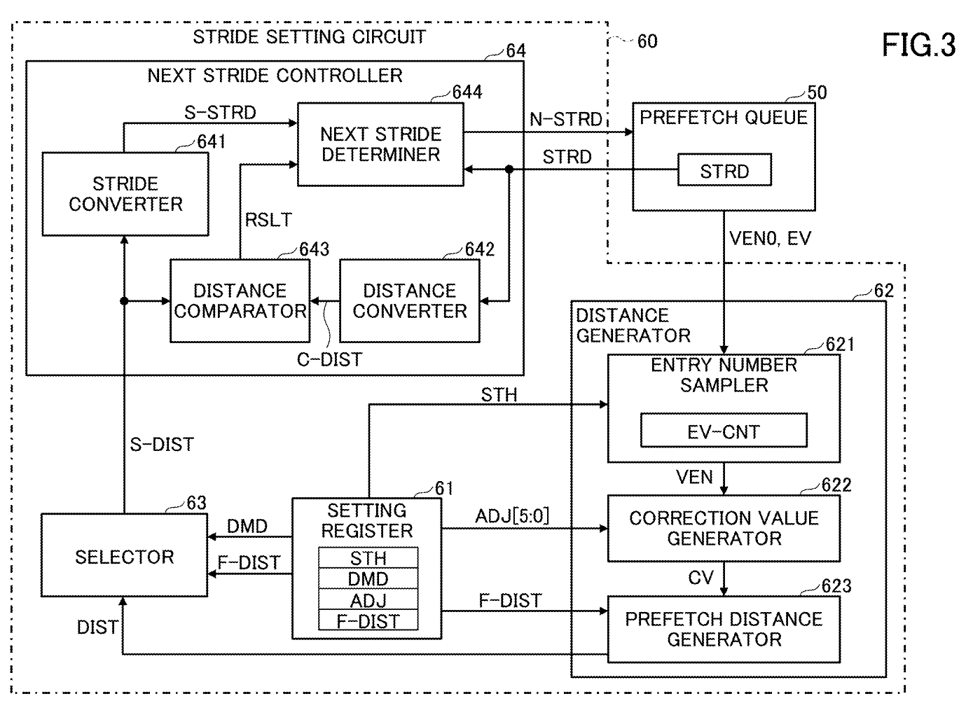

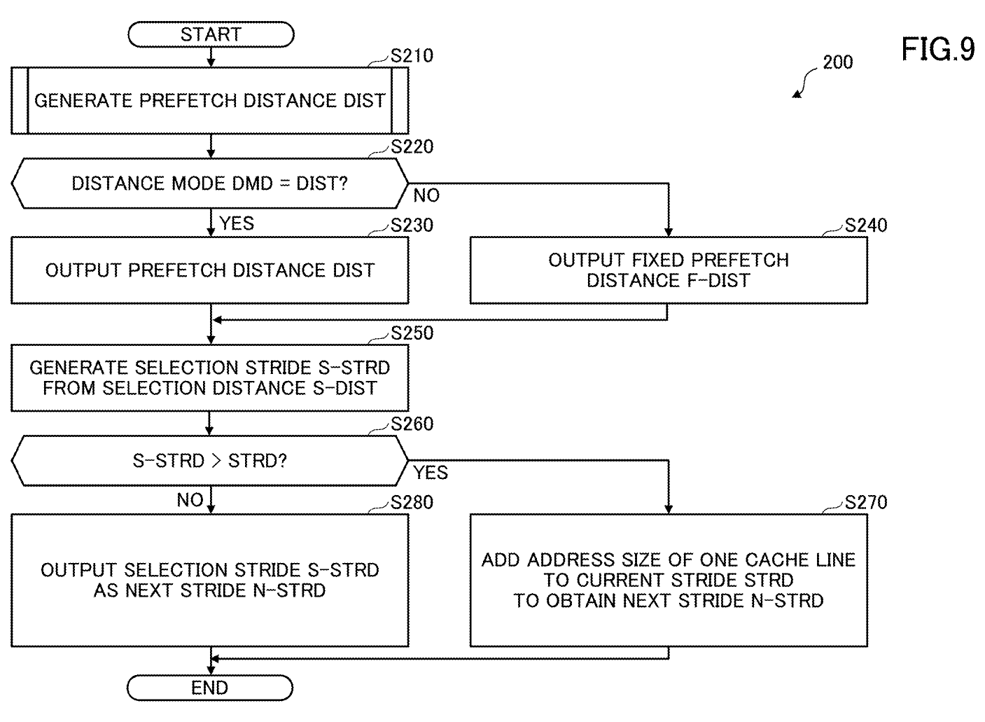

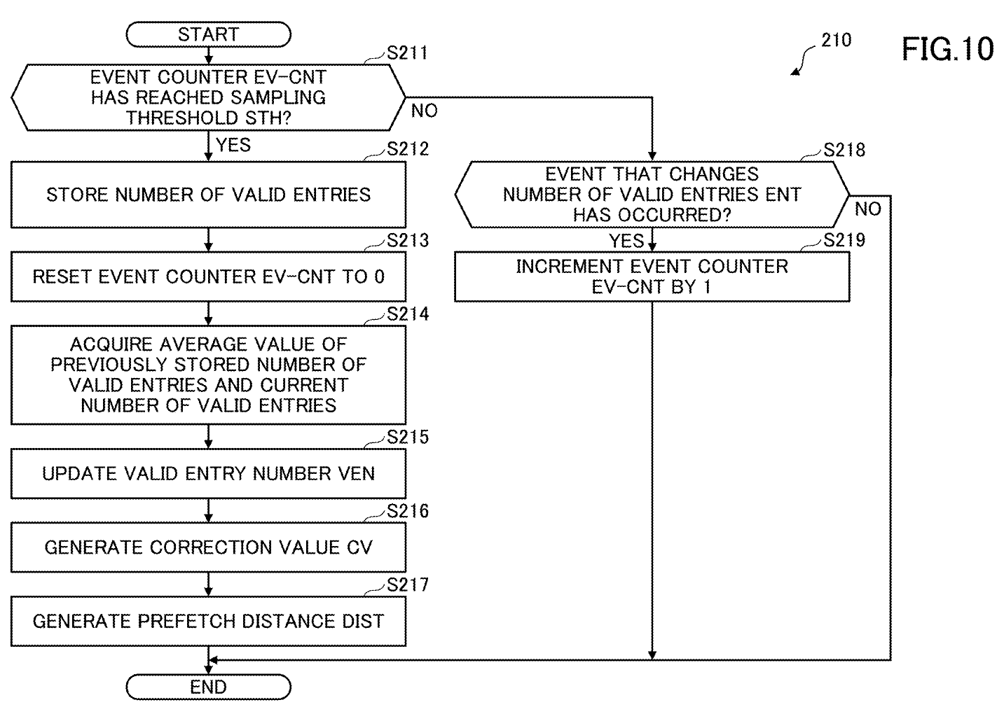

For example, when the stride STRD (the address difference) is 300 and the minimum stride is 100, the prefetch distance is 3. After determining the prefetch distance, the stride setting circuit 60 converts the determined prefetch distance into the stride STRD and stores it in the stride holding section of the prefetch queue 50. The storage of the stride STRD in the stride holding section may be performed by the prefetch queue management circuit 40. An example of the configuration of the stride setting circuit 60 is illustrated in FIG. 3, and an example of the operation of the stride setting circuit 60 is illustrated in FIGS. 9 and 10. Additionally, in the following description, various prefetch distances indicated by the symbol DIST may be referred to simply as distances.

The prefetch request issue circuit 70 issues the prefetch request PFREQ to the memory 200, based on the start instruction PFST from the prefetch queue management circuit 40. The prefetch queue management circuit 40 and the prefetch request issue circuit 70 are examples of a prefetch management circuit.

The L1 cache 80 includes a plurality of cache lines CL configured to hold a part of data held in the memory 200. When the L1 cache controller 20 determines the cache hit L1-HIT of the memory access request REQ, the L1 cache 80 transfers target data to be read held in the hit cache line CL to a general-purpose register or the like, which is not illustrated.

When the L1 cache controller 20 determines the cache miss L1-MIS, the L1 cache 80 stores, in any one of the cache lines CL, one cache line of data including the target data to be read from the memory 200. In FIG. 1, normal data read from the memory 200 without prefetching is indicated by the symbol DT, and data prefetched from the memory 200 is indicated by the symbol PDT.

FIG. 2 illustrates an example of a structure of the prefetch queue 50 of FIG. 1. Each of the entries ENT of the prefetch queue 50 has an area for holding a validity flag VLD, a predicted address P-ADRS, and a counter value R-CNT, and can be assigned to each of the streams. FIG. 2 illustrates an example in which one of the entries ENT is assigned to a stream A and another one of the entries ENT is assigned to a stream B. The area for holding the counter value R-CNT is an example of a match count holding section.

The validity flag VLD is set to, for example, “1” when making the entry ENT valid for use in the stream, and is reset to, for example, “0” when making the entry ENT invalid. Hereinafter, making the entry ENT invalid is also referred to as deleting the entry ENT or unassigning the entry ENT. The entry ENT in the reset state is treated as an empty entry.

The validity flag VLD is reset when a prefetch queue hit PFQhit, indicating that the memory access request REQ belonging to the stream using the entry ENT has continuously occurred, has not occurred for a certain period of time. Additionally, when an entry ENT is to be used for a new stream while all of the entries ENT are in the valid state, the validity flag VLD of the entry ENT whose counter value R-CNT is small is reset in order to create an empty entry.

When a cache miss occurs in the L1 cache 80, an empty entry is newly registered as the entry ENT of the stream corresponding to the memory access request REQ in which the cache miss occurred. The validity flag VLD of the newly registered entry ENT is set to “1”.

In the area of the predicted address P-ADRS, a request address R-ADRS to be included in a memory access request REQ that is predicted to be issued from the instruction issue circuit 10 next in the same stream is stored as a predicted value of the address. The area of the predicted address P-ADRS is an example of a predicted value holding section. When the prefetch queue management circuit 40 determines that the request address R-ADRS of the memory access request REQ is included in the stream managed by the entry ENT, the request address R-ADRS predicted to be issued next is stored as the predicted address P-ADRS.

When the request address R-ADRS included in the memory access request REQ matches the predicted address P-ADRS, the prefetch queue management circuit 40 determines that the prefetch queue 50 is hit. Hereinafter, the hit of the prefetch queue 50 is referred to as the prefetch queue hit PFQhit. The prefetch queue hit PFQhit may simply be indicated by the symbol PFQhit.

The counter value R-CNT is counted up by the prefetch queue management circuit 40 when PFQhit is determined. The counter value R-CNT indicates how many times PFQhit has occurred. A larger value of the counter value R-CNT indicates that the predicted address P-ADRS repeatedly matches the request address R-ADRS and that the prediction reliability is higher.

The stride STRD common to the streams indicates the change amount from the request address R-ADRS of the memory access request REQ to the prefetch destination address of the memory 200. For example, the stride STRD is increased by the address difference from the head address to the tail address of one cache line by the prefetch queue management circuit 40 every time PFQhit is determined. However, upon or after the counter value R-CNT reaching a sampling threshold STH described later, the stride STRD is not increased even if PFQhit is determined and is maintained at the current value. Additionally, when the entry ENT is newly registered, the stride STRD is set to an initial value (the minimum stride), which is the address difference from the head address to the tail address of one cache line.

FIG. 3 illustrates an example of a configuration of the stride setting circuit 60 illustrated in FIG. 1. The stride setting circuit 60 includes a setting register 61, a distance generator 62, a selector 63, and a next stride controller 64. The distance generator 62 includes an entry number sampler 621, a correction value generator 622, and a prefetch distance generator 623. The entry number sampler 621 includes an event counter EV-CNT. The next stride controller 64 includes a stride converter 641, a distance converter 642, a distance comparator 643, and a next stride determiner 644.

The setting register 61 has areas for holding the sampling threshold STH, a distance mode DMD, a 6-bit adjustment value ADJ, and a fixed distance F-DIST, and the values can be rewritten from outside of the processor 100. The sampling threshold STH indicates a value of the event counter EV-CNT that is a trigger for generating a prefetch distance DIST, and is used by the entry number sampler 621.

The distance mode DMD is used by the selector 63 to select the distance DIST or the fixed distance F-DIST. The adjustment value ADJ is used to adjust a correction value CV when the correction value CV is generated by the correction value generator 622 of the distance generator 62. The fixed distance F-DIST is used by the prefetch distance generator 623 of the distance generator 62 to generate the distance DIST, and is the maximum value of the distance DIST.

The entry number sampler 621 receives a valid entry number VEN indicating the number of valid entries ENT in the prefetch queue 50 and an event signal EV indicating the occurrence of an event in which the number of valid entries ENT in the prefetch queue 50 changes. Hereinafter, the number of valid entries ENT is also referred to as the valid entry number.

The event counter EV-CNT of the entry number sampler 621 performs a counting operation each time the event signal EV is received. When a count value of the event counter EV-CNT reaches the sampling threshold STH, the entry number sampler 621 stores the valid entry number indicating the number of valid entries ENT at that time and resets the count value of the event counter EV-CNT to 0.

For example, the event in which the valid entry number changes is the new registration of the entry ENT, the deletion of the entry ENT, or the like, and the count value of the event counter EV-CNT indicates the total value of the number of these events. The deletion of the entry ENT is performed by the prefetch queue management circuit 40 when PFQhit does not occur for a predetermined period. Alternatively, the deletion of the entry ENT is performed by the prefetch queue management circuit 40 when an entry ENT of a new stream is to be registered while all entries ENT of the prefetch queue 50 are valid. When registering an entry ENT of a new stream while all entries ENT of the prefetch queue 50 are valid, one entry ENT having the smallest counter value R-CNT may be deleted.

The entry number sampler 621 includes, for example, two storage units, which are not illustrated, each configured to store the number of valid entries. The two storage units alternately store the number of valid entries when the count value of the event counter EV-CNT reaches the sampling threshold STH. The entry number sampler 621 determines an average value of the current and previous valid entry numbers stored in the two storage units, and outputs the determined average value to the correction value generator 622 as the valid entry number VEN.

Here, the number of the valid entry numbers for which the entry number sampler 621 determines an average value is not limited to two, and may be three or more. Additionally, the entry number sampler 621 may output the valid entry number VEN to the correction value generator 622 every time the count value of the event counter EV-CNT reaches the sampling threshold STH. In this case, the entry number sampler 621 need not include the storage units.

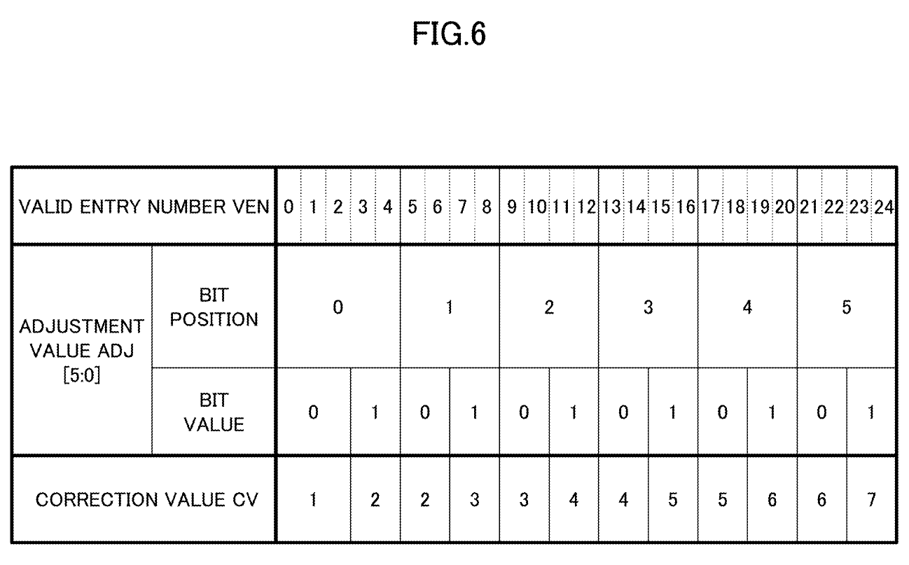

The correction value generator 622 determines the correction value CV to be used for generating the distance DIST based on the valid entry number VEN received from the entry number sampler 621 for each reset cycle of the event counter EV-CNT and the adjustment value ADJ held in the setting register 61. An example of the adjustment value ADJ and an example of how to determine the correction value CV are illustrated in FIG. 6.

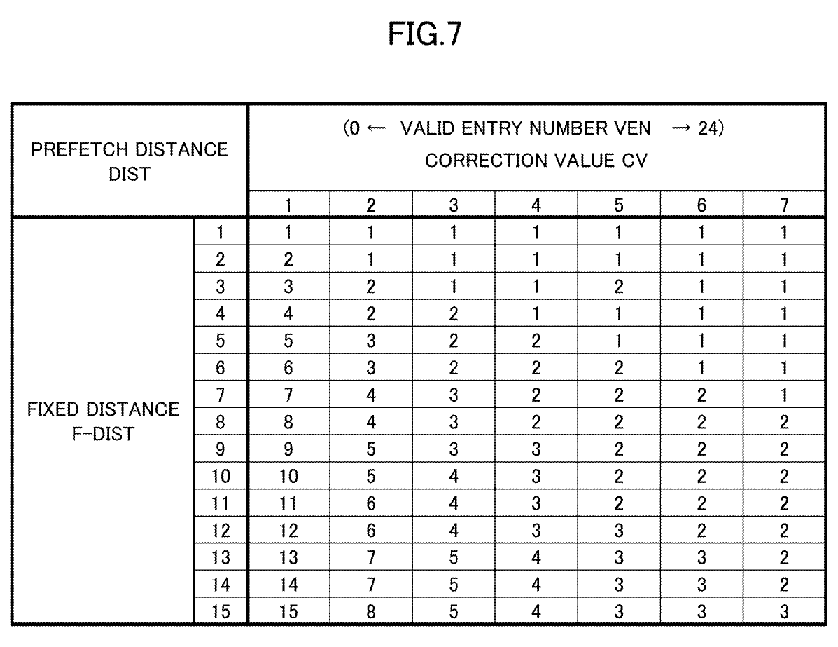

The prefetch distance generator 623 determines the distance DIST as an integer value, based on the correction value CV generated by the correction value generator 622 and the fixed distance F-DIST held in the setting register 61. An example of how to determine the distance DIST is illustrated in FIG. 7.

The selector 63 selects either the distance DIST from the prefetch distance generator 623 or the fixed distance F-DIST held in the setting register 61 according to the distance mode DMD held in the setting register 61. The selector 63 outputs, to the next stride controller 64, the selected distance DIST or fixed distance F-DIST as a selected distance S-DIST.

The stride converter 641 of the next stride controller 64 converts the selected distance S-DIST (an integer value) received from the selector 63 into the selected stride S-STRD (the change amount in the address). The distance converter 642 converts the stride STRD held in the prefetch queue 50 into a distance C-DIST (an integer value) for comparison, and outputs it to the distance comparator 643. The distance comparator 643 compares the distance C-DIST with the selected distance S-DIST, and outputs the comparison result RSLT to the next stride determiner 644.

When the comparison result RSLT is C-DIST ≥ S-DIST, that is, when the stride STRD reaches the selected stride S-STRD, the next stride determiner 644 outputs the selected stride S-STRD as a next stride N-STRD. The next stride N-STRD is stored as the stride STRD in the stride holding section of the prefetch queue 50.

When the comparison result is C-DIST < S-DIST, that is, when the stride STRD does not reach the selected stride S-STRD, the next stride determiner 644 updates the stride STRD and outputs it as the next stride N-STRD. The stride STRD is updated by adding the minimum stride, which is the address difference between the head address and the tail address of one cache line, to the current stride STRD.

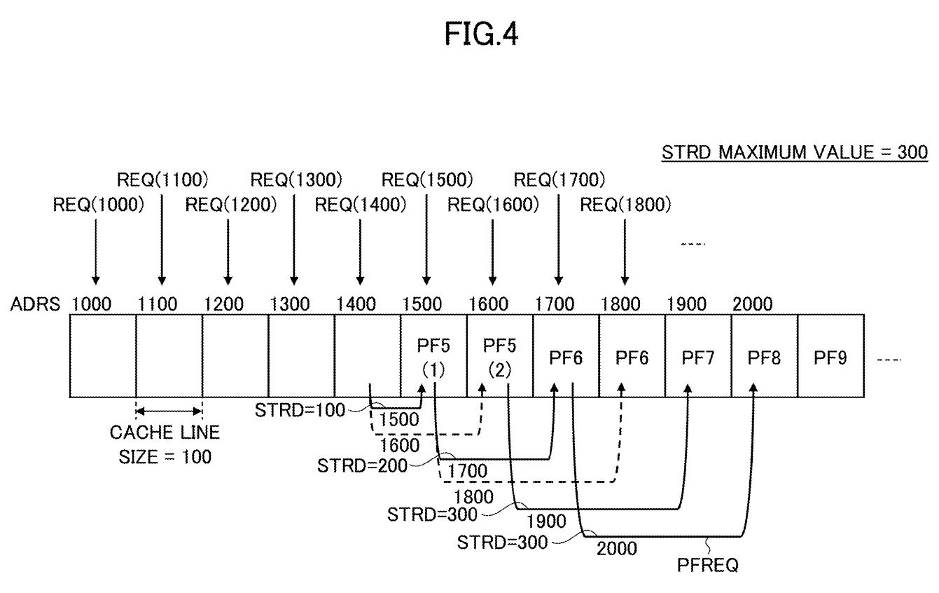

FIG. 4 illustrates an example of a prefetch operation performed by the prefetch controller 30 of FIG. 1. That is, FIG. 4 illustrates an example of a method of controlling the prefetch operation by the processor 100. The prefetch queue 50 includes the plurality of entries ENT, and thus the plurality of stream accesses, which are memory accesses by the plurality of memory access requests REQ for consecutive addresses, can be processed in parallel. FIG. 4 illustrates a prefetch operation of one of the plurality of streams. Although illustration is omitted, it is assumed that the selected distance S-DIST output from the selector 63 in FIG. 3 is 3, and the selected stride S-STRD output from the stride converter 641 in FIG. 3 is 300. Therefore, the maximum value of the stride STRD is 300.

In the example illustrated in FIG. 4, data corresponding to the cache line size of the L1 cache 80 is read by one memory access request REQ, and consecutive memory access requests REQ are determined to be cache misses (L1-MIS). It is assumed that a plurality of request addresses R-ADRS illustrated as numerical values in parentheses of the consecutive memory access requests REQ indicate a plurality of memory blocks each having the same cache line size without overlapping. When a memory access request REQ causes a cache miss, the L1 cache controller 20 illustrated in FIG. 1 issues the data request DREQ, which is not illustrated, to the memory 200 in response to each memory access request REQ.

In order to simplify the description, it is assumed that the cache line size is 100 and the request address R-ADRS included in the first memory access request REQ is 1000. It is assumed that the request address R-ADRS included in the second and subsequent successive memory access requests REQ is increased by 100.

The prefetch controller 30 in FIG. 1 monitors the request address R-ADRS included in the memory access request REQ. The prefetch controller 30 detects a stream access from the access trend of the memory access requests REQ(1000) to REQ(1300).

When the memory access request REQ(1400) is issued, the prefetch controller 30 having detected the stream access issues a prefetch request PFREQ to the address ADRS=1500, which is one cache line size ahead, with the stride STRD defined as 100. The prefetch request PFREQ is illustrated as a solid U-shaped arrow.

Additionally, the prefetch controller 30 issues a prefetch request PFREQ to the address ADRS=1600, which is one cache line size further ahead, as illustrated by a broken U-shaped arrow, so that the prefetching is not missed when the stride STRD successively increases. With this, data for two cache lines indicated by the addresses ADRS=1500, 1600 are prefetched in the memory 200 (PF5(1) and PF5(2)). Here, the stride STRD=100 corresponds to the prefetch distance DIST=1.

Next, when the memory access request REQ(1500) is issued, the prefetch controller 30 increases the stride STRD by 100, to become 200, and issues the prefetch request PFREQ to the address ADRS=1700, which is two cache line sizes ahead. Additionally, the prefetch controller 30 further issues the prefetch request PFREQ to the address ADRS=1800, which is one cache line further ahead. With this, data for two cache lines indicated by the addresses ADRS=1700, 1800 are prefetched in the memory 200 (PF6(1) and PF6(2)). The stride STRD=200 corresponds to the prefetch distance DIST=2.

Next, when the memory access request REQ(1600) is issued, the prefetch controller 30 further increases the stride STRD by 100 to the maximum value 300 and issues the prefetch request PFREQ to the address ADRS=1900, which is three cache line sizes ahead. With this, data for one cache line indicated by the address ADRS=1900 is prefetched in the memory 200 (PF7). The stride STRD=300 corresponds to the prefetch distance DIST=3.

In the example illustrated in FIG. 4, the maximum value of the prefetch distance DIST is set to 3. Subsequently, the prefetch controller 30 repeats the processing of issuing a prefetch request PFREQ to the address ADRS three cache line size ahead, using the stride STRD as 300, as long as the stream access continues.

By issuing two prefetch requests PFREQ whose request addresses are shifted by 100 until the stride STRD reaches the maximum value (=300), the miss of prefetching in the stream access can be prevented. With this, the occurrence of a cache miss due to a miss of prefetching can be prevented, and deterioration of the processing performance of the processor 100 can be suppressed.

In the example illustrated in FIG. 4, prefetching is controlled with the maximum value of the prefetch distance being set to 3 (the maximum value of the stride STRD=300). The prefetch distance is ideally set such that the memory access request REQ is processed and a cache hit occurs immediately after data PDT is read from the memory 200 into the L1 cache 80 by prefetching. Therefore, for example, it is preferable that the data is stored in the L1 cache 80 by the prefetch request PFREQ issued based on the memory access request REQ(1600) immediately before the memory access request REQ(1900).

However, if the prefetch distance is too short, the memory access request REQ for the data is issued before the data is stored in the L1 cache 80 by prefetching, which may result in a cache miss. In this case, the effect of prefetching cannot be obtained, and the performance of the processor 100 may be degraded.

Conversely, if the prefetch distance is too long and the data is stored in the L1 cache 80 too early, necessary data is evicted from the L1 cache 80, which may result in a cache miss. In this case, the performance of the processor 100 may be degraded. However, in the present embodiment, as described with reference to FIGS. 9 and 10, the prefetch distance (i.e., the stride STRD) is appropriately set in accordance with the number of valid entries used in the stream. With this, the occurrence frequency of the cache miss can be suppressed, thereby suppressing deterioration of the processing performance of the processor 100.

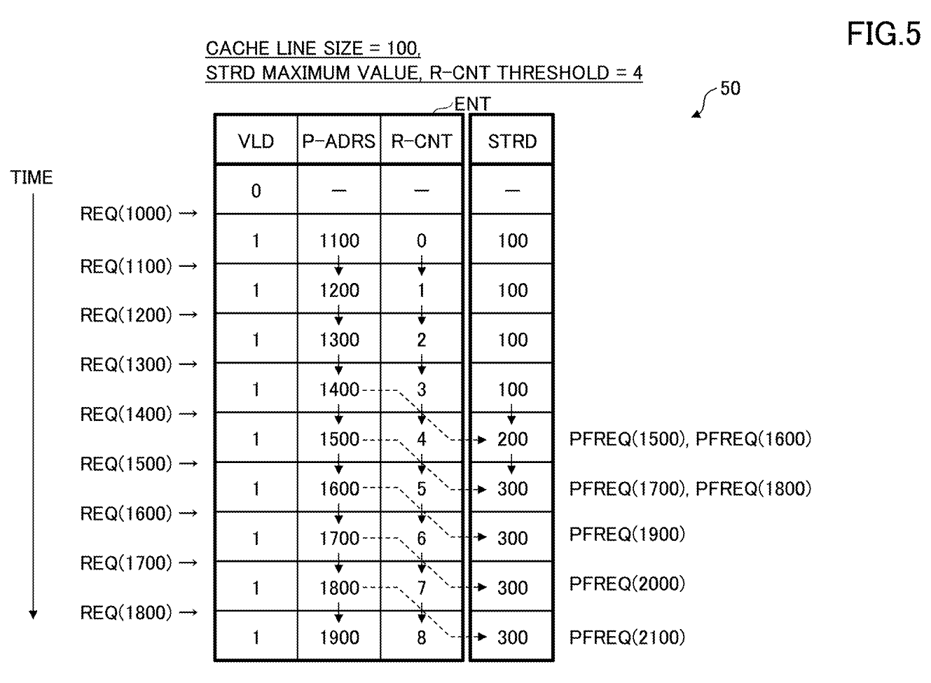

FIG. 5 illustrates an example of a change in a state of the entries ENT of the prefetch queue 50 when the operation of FIG. 4 is performed. That is, FIG. 5 illustrates an example of a method of controlling the prefetch operation by the processor 100. Here, it is assumed that before the operation of FIG. 5 is started, no other stream access is performed and the stride holding section does not hold the stride STRD.

First, when the memory access request REQ(1000) causes a cache miss, the prefetch queue management circuit 40 searches for an empty entry having the validity flag VLD=0. The prefetch queue management circuit 40 sets the validity flag VLD of the empty entry to 1 and sets the entry ENT to a valid state, so that the entry ENT is newly registered in the prefetch queue 50.

The prefetch queue management circuit 40 sets the predicted address P-ADRS of the entry ENT to the address (1100), which is the cache line size ahead of the memory access request REQ(1000). Additionally, the prefetch queue management circuit 40 resets the counter value R-CNT to 0 and sets the stride STRD to 100, which is the cache line size, when the entry ENT is newly registered.

Next, when the memory access request REQ(1100) has been issued, the prefetch queue management circuit 40 compares the address ADRS=1100 included in the memory access request REQ with the predicted address P-ADRS. Since the address ADRS matches the predicted address P-ADRS, the prefetch queue management circuit 40 detects PFQhit and adds 100 to the predicted address P-ADRS to set it to 1200. Additionally, since the prefetch queue management circuit 40 detects PFQhit, the counter PFQ-CNT is incremented by 1.

Next, the memory access requests REQ(1200) and REQ(1300) are issued sequentially. The prefetch queue management circuit 40 operates in the same manner as in the case of issuing the memory access request REQ(1100), and sequentially sets the predicted address P-ADRS to 1300 and 1400, and sequentially counts up the counter PFQ-CNT to 2 and 3.

Next, the memory access request REQ(1400) is issued. The prefetch queue management circuit 40 sets the predicted address P-ADRS to 1500 and counts up the counter PFQ-CNT to 4. Here, since a threshold value of the counter PFQ-CNT is set to 4, the counter value R-CNT reaches the threshold value. When the counter value R-CNT reaches the threshold value, that is, when the number of times the request address R-ADRS and the predicted address P-ADRS match reaches the threshold value, the prefetch queue management circuit 40 starts to issue the start instruction PFST by using the stride STRD. The threshold value of the counter value R-CNT serving as a trigger for issuing the start instruction PFST is an example of a first threshold value.

By starting to issue the start instruction PFST using the stride STRD, based on the counter value R-CNT having reached the threshold value, the start of prefetching can be prevented when the stream access is not performed. As a result, data that is not used by the processor 100 can be prevented from being stored in the L1 cache 80, and a decrease in the use efficiency of the L1 cache 80 can be suppressed.

The prefetch queue management circuit 40 adds 100 to the request address R-ADRS=1400 included in the memory access request REQ, and issues the start instruction PFST of the prefetch request PFREQ(1500) to the prefetch request issue circuit 70. Since the stride STRD has not reached the maximum value 300 indicated by the selected stride S-STRD, the prefetch queue management circuit 40 increases the stride STRD by 100 to set it to 200. Additionally, when the stride STRD has not reached the maximum value, the prefetch queue management circuit 40 issues the start instruction PFST of the prefetch request PFREQ(1600) to the prefetch request issue circuit 70 in order to prefetch data one cache line further ahead.

Next, the memory access request REQ(1500) is issued. The prefetch queue management circuit 40 sets the predicted address P-ADRS to 1600 and counts up the counter PFQ-CNT to 5. Since the counter value R-CNT exceeds the threshold value=4, the prefetch queue management circuit 40 adds the stride STRD=200 to the request address R-ADRS=1500 included in the memory access request REQ.

Then, the prefetch queue management circuit 40 issues a start instruction PFST of the prefetch request PFREQ(1700) to the prefetch request issue circuit 70. Additionally, the stride STRD has not reached the maximum value 300, and thus the prefetch queue management circuit 40 issues a start instruction PFST of the prefetch request PFREQ(1800) to the prefetch request issue circuit 70 in order to prefetch one cache line further ahead.

Since the stride STRD has not reached the maximum value 300, the prefetch queue management circuit 40 increases the stride STRD by 100 and sets it to 300. With this, the stride STRD becomes the maximum value 300, so that the stride STRD is maintained at 300 without increasing in subsequent operations.

Next, the memory access request REQ(1600) is issued. The prefetch queue management circuit 40 sets the predicted address P-ADRS to 1700 and counts up the counter PFQ-CNT to 7. The prefetch queue management circuit 40 adds the stride STRD=300 to the request address R-ADRS=1600 included in the memory access request REQ and issues a start instruction PFST of the prefetch request PFREQ(1900) to the prefetch request issue circuit 70.

Since the stride STRD is set to the maximum value 300, one cache line further ahead is not prefetched. Subsequently, the prefetch queue management circuit 40 issues a start instruction PFST of the prefetch request PFREQ to the prefetch request issue circuit 70 every time the memory access request REQ is issued by the stream access. At this time, the start instruction PFST of the prefetch request PFREQ includes a request address obtained by adding the stride STRD=300 to the request address R-ADRS included in the memory access request REQ.

FIG. 6 illustrates an example of a method of generating the correction value CV by the correction value generator 622 illustrated in FIG. 3. The correction value CV is generated based on the valid entry number VEN and the value of each bit of the 6-bit adjustment value ADJ[5:0]. The valid entry number VEN is associated with the bit position of the adjustment value ADJ[5:0] by a predetermined number, and is divided into six groups. For each of the groups of the valid entry number VEN, one of two correction values CV is generated as the correction value CV in accordance with the bit value of the adjustment value ADJ corresponding to the group.

The correction value CV increases in accordance with an increase in the valid entry number VEN, and the amount of increase in the correction value CV is set less than the amount of increase in the valid entry number VEN. With this, the amount of increase in the correction value CV in accordance with the increase in the valid entry number VEN can be suppressed, and an excessive increase in the correction value CV in a range where the valid entry number VEN is large can be suppressed. As a result, an appropriate prefetch distance DIST can be generated by using an appropriate correction value CV.

Additionally, the correction value CV can be finely adjusted by using the adjustment value ADJ, and thus the prefetch distance generator 623 can generate an appropriate prefetch distance DIST by using the finely adjusted correction value CV.

FIG. 7 illustrates an example of a method of generating the prefetch distance DIST by the prefetch distance generator 623 illustrated in FIG. 3. The prefetch distance generator 623 generates the prefetch distance DIST based on the fixed distance F-DIST, which is the fixed prefetch distance set in the setting register 61, and the correction value CV generated by the correction value generator 622.

For example, with respect to the request address R-ADRS, the increment of the request address included in the prefetch request PFREQ is at most a value obtained by multiplying the request address R-ADRS included in the memory access request REQ issued from the instruction issue circuit 10 by the prefetch distance DIST. For example, when the cache line size CL is 64 bytes and the prefetch distance DIST is 3, the request address included in the prefetch request PFREQ is 64 × 3 bytes ahead of the request address R-ADRS included in the memory access request REQ.

For example, the table in FIG. 7 may be generated as a conversion table in which the prefetch distance DIST is described corresponding to each of the plurality of correction values CV, and in this case, the prefetch distance generator 623 may determine the prefetch distance DIST using the conversion table. By using the conversion table to determine the prefetch distance DIST, the prefetch distance DIST can be easily determined. Here, the prefetch distance generator 623 may determine the prefetch distance DIST by rounding up the decimal part of the quotient obtained by dividing the fixed distance F-DIST by the correction value CV.

The prefetch distance DIST generated by the prefetch distance generator 623 increases as the valid entry number VEN decreases and the correction value CV decreases, and decreases as the valid entry number VEN increases and the correction value CV increases. Then, the next stride controller 64 sets the selected stride S-STRD, which is the maximum value of the stride STRD, based on the prefetch distance DIST generated by the prefetch distance generator 623.

With this, when the usage rate of the valid entry ENT is high, the prefetch distance DIST can be reduced so that necessary data is not evicted from the L1 cache 80. Conversely, when the usage rate of the valid entry ENT is low, the prefetch distance DIST can be increased so that a prefetch request PFREQ having an appropriate distance is issued.

FIG. 8 illustrates an example of an operation of the prefetch queue management circuit 40 of FIG. 1. That is, FIG. 8 illustrates an example of a method of controlling, by the processor 100, the prefetch operation. First, in step S101, the prefetch queue management circuit 40 receives the request address R-ADRS, along with the issuance of the memory access request REQ. Next, in step S102, the prefetch queue management circuit 40 determines the cache miss or cache hit of the L1 cache 80 based on the cache miss signal L1-MIS received from the L1 cache controller 20.

Here, although not illustrated in the operation flow of FIG. 8, the cache miss is determined by the L1 cache controller 20 of FIG. 1. When the L1 cache controller 20 determines the cache miss, the L1 cache controller 20 issues the data request DREQ to the memory 200 (i.e., the memory access request to the memory 200).

In the case of the cache miss, in step S103, the prefetch queue management circuit 40 determines whether PFQhit has occurred. PFQhit is determined when there is an entry ENT of the same stream as the request address R-ADRS for which the cache miss occurred, and the request address R-ADRS matches the predicted address P-ADRS. The prefetch queue management circuit 40 performs step S200 when PFQhit has occurred, and performs step S108 when PFQhit has not occurred.

In the case of the cache hit, in step S104, the prefetch queue management circuit 40 determines whether PFQhit has occurred. The prefetch queue management circuit 40 performs step S200 when PFQhit has occurred, and terminates the operation illustrated in FIG. 8 when PFQhit has not occurred.

In step S200, the prefetch queue management circuit 40 instructs the stride setting circuit 60 to generate the stride STRD, and performs step S105. The generation of the stride STRD in step S200 is performed by the stride setting circuit 60. An example of the operation of step S200 is illustrated in FIGS. 9 and 10.

In step S105, the prefetch queue management circuit 40 updates the prefetch queue 50 as described with reference to FIG. 5. Next, in step S106, the prefetch queue management circuit 40 determines whether the issuing condition of the prefetch request PFREQ is satisfied based on the information held in the updated prefetch queue 50. When the issuing condition of the prefetch request PFREQ is satisfied, the prefetch queue management circuit 40 performs step S107, and when the issuing condition of the prefetch request PFREQ is not satisfied, the operation illustrated in FIG. 8 is terminated.

In step S107, the prefetch queue management circuit 40 outputs the start instruction PFST to the prefetch request issue circuit 70 in order to issue the prefetch request PFREQ. The maximum value of the request address included in the prefetch request PFREQ issued to the memory 200 by the prefetch request issue circuit 70 is generated by adding the stride STRD to the request address R-ADRS received in step S101.

In step S108, the prefetch queue management circuit 40 determines whether there is an empty entry in the prefetch queue 50. When there is an empty entry in the prefetch queue 50, the prefetch queue management circuit 40 performs step S109, and when there is no empty entry in the prefetch queue 50, the prefetch queue management circuit 40 terminates the operation illustrated in FIG. 8. In step S109, the prefetch queue management circuit 40 registers a new entry ENT, and terminates the operation illustrated in FIG. 8.

FIG. 9 illustrates an example of the operation of step S200 of FIG. 8. First, in step S210, the stride setting circuit 60 generates the prefetch distance DIST by the distance generator 62 of FIG. 3. An example of the operation of step S210 is illustrated in FIG. 10.

Next, the selector 63 of FIG. 3 performs step S230 when the distance mode DMD indicates the selection of the prefetch distance DIST in step S220, and performs step S240 when the distance mode DMD indicates the fixed distance F-DIST. In step S230, the selector 63 selects the prefetch distance DIST generated by the distance generator 62, outputs it to the stride converter 641 as the selected distance S-DIST, and performs the operation of step S250. The selected distance S-DIST is an integer indicating the maximum number of blocks ahead to which the prefetch request PFREQ is to be issued, with one cache line CL defined as one block.

In step S240, the selector 63 selects the fixed distance F-DIST set in the setting register 61, outputs it to the stride converter 641 as the selected distance S-DIST, and performs the operation of step S250. By outputting the fixed distance F-DIST to the stride converter 641 as the selected distance S-DIST, for example, a constant selected stride S-STRD, which is the maximum value of the stride STRD, can be set regardless of the number of streams.

For example, when the processor 100 executes a large number of small programs in parallel while switching and the number of streams tends to change, the frequency of changes in the number of valid entries increases. In this case, the frequency of generation of the prefetch distance DIST also increases, and it may become difficult to set an appropriate stride STRD in accordance with the change in the number of streams. In such a case, by setting the selected stride S-STRD based on the fixed distance F-DIST, the possibility of setting an appropriate stride STRD can be increased, in comparison with the case where the frequency of generation of the prefetch distance DIST is high.

In step S250, the stride converter 641 generates the selected stride S-STRD indicating the maximum value of the address difference of the prefetch destination by using the integer value indicated by the selected distance S-DIST received from the selector 63. The stride converter 641 outputs the generated selected stride S-STRD to the next stride determiner 644.

Next, in step S260, the next stride determiner 644 compares the current stride STRD held in the prefetch queue 50 with the selected stride S-STRD generated by the stride converter 641. When the current stride STRD is less than the selected stride S-STRD, the next stride determiner 644 performs step S270. When the current stride STRD is larger than or equal to the selected stride S-STRD, the next stride determiner 644 performs step S280.

In step S270, the next stride determiner 644 adds the address size of one cache line to the current stride STRD, outputs it to the prefetch queue 50 as the next stride N-STRD, and terminates the operation illustrated in FIG. 9. In step S280, the next stride determiner 644 outputs the selected stride S-STRD to the prefetch queue 50 as the next stride N-STRD, and terminates the operation illustrated in FIG. 9.

FIG. 10 illustrates an example of the operation of step S210 of FIG. 9. The operation illustrated in FIG. 10 is performed by the distance generator 62 of FIG. 3. First, in step S211, the entry number sampler 621 determines whether the event counter EV-CNT has reached the sampling threshold STH. The sampling threshold STH is an example of a second threshold. The entry number sampler 621 performs step S212 when the event counter EV-CNT has reached the sampling threshold STH, and performs step S218 when the event counter EV-CNT has not reached the sampling threshold STH.

In step S212, the entry number sampler 621 stores the current number of valid entries in the prefetch queue 50. Next, in step S213, the entry number sampler 621 resets the event counter EV-CNT to “0”. Next, in step S214, the entry number sampler 621 determines an average value of the previously stored number of valid entries and the current number of valid entries.

The number of valid entries may differ from the number of streams, which are the plurality of memory acceses for consecutive addresses. This is because, for example, there is a time lag between the start of the plurality of memory accesses for consecutive addresses and the registration of new entries ENT in step S109 of FIG. 8. Therefore, by using the average value of the number of valid entries at this time and the previous time, the difference from the actual number of streams can be reduced, and the accuracy of generation of the prefetch distance DIST can be improved.

Here, when the difference between the number of valid entries and the number of streams can be ignored, the entry number sampler 621 may use the number of valid entries at this time as it is without determining the average value in step S214. In this case, the storage unit for storing the number of valid entries can be eliminated, and the processing of determining the prefetch distance DIST can be simplified.

As described above, the entry number sampler 621 can indirectly determine the number of streams by a simple method using the number of valid entries, and can generate an appropriate prefetch distance DIST in accordance with the number of streams. If the number of valid entries is not used, it is necessary to estimate the number of streams by analyzing the request addresses R-ADRS included in all memory access requests, which increases the circuit scale of the processor 100.

In step S215, the entry number sampler 621 updates the valid entry number VEN to be passed to the correction value generator 622. Next, in step S216, the correction value generator 622 generates the correction value CV by using the valid entry number VEN updated by the entry number sampler 621 and the adjustment value ADJ[5:0], as illustrated in FIG. 6. Next, in step S217, the prefetch distance generator 623 determines the prefetch distance DIST by using the correction value CV generated by the correction value generator 622 and the fixed distance F-DIST, as illustrated in FIG. 7, and terminates the operation illustrated in FIG. 10.

By outputting the valid entry number VEN to the correction value generator 622 by using the sampling threshold STH set in the setting register 61, the generation frequency of the prefetch distance DIST can be changed from outside of the processor 100. Thus, the prefetch distance DIST can be generated more appropriately according to the characteristics of the program executed by the processor 100, and the stride STRD, which is the address interval of the prefetch request PFREQ, can be set more appropriately.

In step S218, the entry number sampler 621 determines whether an event in which the valid entry number changes has occurred. When the event in which the valid entry number changes has occurred, the entry number sampler 621 performs step S219, and when the event in which the valid entry number changes has not occurred, the operation of FIG. 10 is terminated. In step S219, the entry number sampler 621 increments the event counter EV-CNT by 1, and the operation of FIG. 10 is terminated.

As described above, in the present embodiment, when the usage rate of the valid entries ENT is high and the frequency of issuing the memory access request REQ for each stream is low, necessary data can be prevented from being easily evicted from the L1 cache 80 by reducing the prefetch distance DIST. When the usage rate of the valid entries ENT is low and the frequency of issuing the memory access request REQ for each stream is high, a prefetch request PFREQ having an appropriate distance can be issued by increasing the prefetch distance DIST. That is, the processing performance of the processor 100 can be improved by dynamically changing the prefetch distance in accordance with the number of valid entries ENT.

By using the valid entry number VEN, the number of streams can be indirectly determined by a simple method, and an appropriate prefetch distance DIST can be generated in accordance with the number of streams.

By outputting the valid entry number VEN to the correction value generator 622 using the sampling threshold STH set in the setting register 61, the generation frequency of the prefetch distance DIST can be changed from outside of the processor 100. With this, the prefetch distance DIST can be generated more appropriately according to the characteristics of the program executed by the processor 100, and the stride STRD, which is the address interval of the prefetch request PFREQ, can be set more appropriately.

The average value of the number of valid entries at this time and the previous time is set as the valid entry number VEN, so that the difference from the actual number of streams can be reduced by using the average value, and the accuracy of generation of the prefetch distance DIST can be improved.

The correction value CV increases as the valid entry number VEN increases, and the amount of increase in the correction value CV is set less than the amount of increase in the valid entry number VEN. With this, the amount of increase in the correction value CV as the valid entry number VEN increases can be suppressed, and the excessive increase in the correction value CV in the range where the valid entry number VEN is large can be suppressed. As a result, an appropriate prefetch distance DIST can be generated by using the appropriate correction value CV.

The prefetch distance DIST can be easily determined by determining the prefetch distance DIST by using the conversion table in which the prefetch distance DIST is described corresponding to each of the plurality of correction values CV.

By selecting the fixed distance F-DIST by the selector 63 and outputting it to the stride converter 641 as the selected distance S-DIST, for example, a constant selected stride S-STRD, which is the maximum value of the stride STRD, can be set regardless of the number of streams.

By starting to issue the start instruction PFST by using the stride STRD, based on the counter value R-CNT having reached the threshold value, the start of prefetching can be prevented when the stream access is not performed. As a result, data that is not used by the processor 100 can be suppressed from being stored in the L1 cache 80, and deterioration in the use efficiency of the L1 cache 80 can be suppressed.

By issuing two prefetch requests PFREQ whose request addresses are shifted by the cache line size until the stride STRD reaches the maximum value, the miss of prefetching in the stream access can be prevented. With this, the occurrence of the cache miss due to the miss of prefetching can be prevented, and deterioration in the processing performance of the processor 100 can be suppressed.

The above detailed description makes clear the features and advantages of the embodiments. It is intended that the scope of the claims extends to the features and advantages of the embodiments as described above without departing from the spirit and scope of the claims. Additionally, a person having ordinary knowledge in the technical field should be able to easily imagine all improvements and modifications. Therefore, it is not intended to limit the scope of inventive embodiments to those described above, but can be based on suitable improvements and equivalents within the scope disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor comprising:
a cache configured to hold data read from a memory by a memory access request;
a prefetch queue including a plurality of entries to be respectively assigned to streams, each of the plurality of entries being used to control prefetching of data from the memory to the cache for a corresponding stream among the streams, the streams being a plurality of memory access requests for consecutive addresses;
a stride setting circuit configured to adjust a stride in accordance with a number of valid entries to which the streams are respectively assigned among the plurality of entries, and reduce the stride as the number of the valid entries increases, the stride being a change amount between an access address included in the memory access request and a prefetch destination address; and
a prefetch management circuit configured to issue a prefetch request to the memory, using the stride adjusted by the stride setting circuit, for each of the memory access requests for the consecutive addresses, upon or after a number of the memory access requests for the consecutive addresses reaching a preset first threshold value for each of the streams.

2. The processor as claimed in claim 1, wherein the stride setting circuit determines the stride based on the number of the valid entries when a total value of a number of newly assigned entries and a number of unassigned entries reaches a preset second threshold value, the newly assigned entries and the unassigned entries being among the plurality of entries.

3. The processor as claimed in claim 2, wherein the stride setting circuit determines the stride based on an average value of the number of the valid entries at each time the total value reaches the preset second threshold value, the total value being reset to 0 each time the total value reaches the preset second threshold value.

4. The processor as claimed in claim 2, wherein the stride setting circuit includes:
a correction value generator configured to generate a correction value corresponding to the number of valid entries;
a prefetch distance generator configured to generate a prefetch distance indicating a number of units of the stride that is set based on the correction value, when a minimum stride is defined as one unit; and
a stride converter configured to convert the stride used in the prefetch request from the prefetch distance,
wherein the correction value generator increases the correction value in accordance with an increase in the number of valid entries, and sets an amount of the increase in the correction value to be less than an amount of the increase in the number of valid entries.

5. The processor as claimed in claim 4, wherein the prefetch distance generator includes a conversion table in which the prefetch distance corresponding to each of a plurality of said correction values is described, and determines the prefetch distance corresponding to the correction value by referring to the conversion table.

6. The processor as claimed in claim 5,
wherein the stride setting circuit includes a selector configured to select either the prefetch distance generated by the prefetch distance generator or a fixed prefetch distance and output the selected prefetch distance to the stride converter, and
wherein the stride converter converts the prefetch distance output from the selector into the stride.

7. The processor as claimed in claim 1,
wherein the prefetch queue includes:
a predicted value holding section configured to hold a predicted value of the access address included in the memory access request that is issued next; and
a match count holding section configured to hold a number of times the access address included in the memory access request matches the predicted value, and
wherein the prefetch management circuit issues the prefetch request each time the access address matches the predicted value, upon or after the number of times the access address matches the predicted value reaching the first threshold value.

8. The processor as claimed in claim 1,
wherein the stride that is set by the stride setting circuit in accordance with the number of valid entries is a maximum value of the stride used for the prefetch request, and
wherein the stride setting circuit sequentially increases the stride for each of the memory access requests for the consecutive addresses until the stride reaches the maximum value upon or after the number of the memory access requests for the consecutive addresses reaching the first threshold value, and issues a plurality of said prefetch requests for each of the memory access requests until the stride reaches the maximum value.

9. An information processing device comprising:
a processor; and
a memory configured to store data to be used by the processor,
wherein the processor includes:
a cache configured to hold data read from a memory by a memory access request;
a prefetch queue including a plurality of entries to be respectively assigned to streams, each of the plurality of entries being used to control prefetching of data from the memory to the cache for a corresponding stream among the streams, the streams being a plurality of memory access requests for consecutive addresses;
a stride setting circuit configured to adjust a stride in accordance with a number of valid entries to which the streams are respectively assigned among the plurality of entries, and reduce the stride as the number of the valid entries increases, the stride being a change amount between an access address included in the memory access request and a prefetch destination address; and
a prefetch management circuit configured to issue a prefetch request to the memory, using the stride adjusted by the stride setting circuit, for each of the memory access requests for the consecutive addresses, upon or after a number of the memory access requests for the consecutive addresses reaching a preset first threshold value for each of the streams.

10. A control method of a processor including a cache configured to hold data read from a memory by a memory access request; and a prefetch queue including a plurality of entries to be respectively assigned to streams, each of the plurality of entries being used to control prefetching of data from the memory to the cache for a corresponding stream among the streams, the streams being a plurality of memory access requests for consecutive addresses, the control method comprising:
adjusting a stride in accordance with a number of valid entries to which the streams are respectively assigned among the plurality of entries, and reducing the stride as the number of the valid entries increases, the stride being a change amount between an access address included in the memory access request and a prefetch destination address; and
issuing a prefetch request to the memory, using the adjusted stride, for each of the memory access requests for the consecutive addresses, upon or after a number of the memory access requests for the consecutive addresses reaching a preset first threshold value for each of the streams.
